(19) United States
(12) Patent Application Publication
(10) Pub. No.: US 2004/0239872 A1
(43) Pub. Date: Dec. 2, 2004

(54) Hook pad for securing sunglasses to eyeglasses

(76) Inventor: Yin Man Chow, Tsuen Wan (HK)

Correspondence Address: JACOBSON HOLMAN PLLC, 400 SEVENTH STREET N.W., SUITE 600, WASHINGTON, DC, 20004, US

(21) Appl. No.: 10/660,700

(22) Filed: Sep. 12, 2003

Related U.S. Application Data
(63) Continuation-in-part of application No. 10/449,111, filed on Jun. 2, 2003, now Pat. No. 6,799,846.

(51) Int. Cl. G02C 9/00

(52) U.S. Cl. 351/47

(57) ABSTRACT

A specially designed hook pad which includes a groove or opening for receipt of the bridge portion of a pair of sunglasses or sunlenses. Two screws pass through a front edge of a front projection of the hook pad and force the bridge portion of the sunglasses or sunlenses to either be frictionally held against a central projection of the hook pad or receive the screws in screw holes in the bridge portion. A second groove or opening defined between the central projection of the hook pad and a rear projection fits over the bridge of a pair of prescription eyeglasses. The hook pad holds the sunglasses or sunlenses in front of the lenses of the pair of prescription eyeglasses. A crosspiece of the hook pad interconnects the front, central and rear projections of the hook pad.

This application is a continuation-in-part application of application Ser. No. 10/449,111, filed Jun. 2, 2003, and hereby incorporated in its entirety by reference.

### FIELD OF THE INVENTION

The present invention relates to a hook pad which is secured to sunglasses or sunlenses to facilitate the mounting of the sunglasses or sunlenses on a bridge of a pair of prescription eyeglasses.

### BACKGROUND OF THE INVENTION

There are many different systems directed to the mounting of sunglasses in front of the lenses of a pair of prescription eyeglasses. These assemblies are commonly referred to as “clip-ons”. As their name implies, a sunglass frame is secured around the rims holding the lenses in a prescription eyeglass frame. Usually, the plurality of pins projecting from the sunglass frame curve around the front and project onto the rear surface of the prescription eyeglass lenses.

Oftentimes, the existing assemblies for clipping on a sunglass frame to a pair of prescription glasses is complicated in its construction and particularly difficult to mount onto an eyeglass frame, particularly when one is driving or participating in an activity that demands their attention. Therefore, there is a need for sunglasses which may easily and quickly be fit onto any pair of eyeglasses.

### SUMMARY OF THE INVENTION

Accordingly, it is an object of the present invention to quickly and easily, with little mechanical dexterity, clip a pair of sunglasses or sunlenses onto a bridge portion or temple portions of a pair of prescription eyeglasses.

This object is accomplished by a specially designed hook pad which includes a groove or opening for receipt of the bridge portion of a pair of sunglasses or sunlenses. Two screws pass through a front edge of a front projection of the hook pad and force the bridge portion of the sunglasses or sunlenses to either be frictionally held against a central projection of the hook pad or receive the screws in screw holes in the bridge portion.

A second groove or opening defined between the central projection and a rear projection of the hook pad fits over the bridge of a pair of prescription eyeglasses. The hook pad holds the sunglasses or sunlenses in front of the lenses of the pair of prescription eyeglasses. A crosspiece of the hook pad interconnects the front, central and rear projections of the hook pad.

The hook pad is of a configuration so as to align two pad portions of the hook pad with the nose pads of the pair of prescription eyeglasses onto which the pair of sunglasses or sunlenses are mounted. This facilitates further support of the sunglasses or sunlenses on the pair of prescription eyeglasses.

An embedded metal reinforcement frame in the hook pad strengthens the hook pad which is otherwise made of plastic material. The metal reinforcement frame is U-shaped and extends between the front projection and rear projection and across a crosspiece of the nose pad. Particular strengthening is provided in the portions of the front projection through which two screws pass to secure the nose pad to the pair of sunglasses or sunlenses.

Alternatively, hook projections may be secured to the bridge or the bridge and the temple portions of a pair of sunglasses or sunlenses to be mounted onto prescription eyeglasses. These hook portions engage and secure the sunglasses or sunlenses to the prescription eyeglasses.

In another arrangement, U-shaped connectors are secured by screws to the bridge portion or to the bridge portion and to the temple portions of the sunglasses or sunlenses to be mounted on prescription eyeglasses. The U-shaped connectors include a front projection, a central projection and a rear projection interconnected by a cross piece.

A screw passes through the front projection and engages the bridge or the temple portions of the sunglasses with the central portion of the U-shaped connector being located behind the bridge portion or temple portions of the sunglasses. Continued screwing of the screw forces the screw to be engaged and retained by the bridge portion or temple portions of the sunglasses or sunlenses. The gap between the central projection and the rear projection is used to hook onto the bridge-portion or the bridge portion and the temple portions of the prescription eyeglasses.

In other embodiments, the sunglasses or sunlenses are specifically designed to cooperate with at least one connector for engaging the sunglasses or sunlenses with prescription eyeglasses. In one alternate embodiment, a bridge connector portion includes two connectors at its terminal ends. One side of the connectors engage a bridge cross piece and on the opposite side engage specifically configured sunlenses having a projection that fits into and is retained by a screw in the bridge connector portion. The bridge connector portion also includes a U-shaped gap for engaging the bridge portion of a pair of prescription eyeglasses.

Alternatively, a bridge portion of a pair of sunglasses includes a slot into which a connector portion is passed to lock onto the bridge portion of the sunglasses. The connector also includes a gap for fitting onto the bridge portion of a pair of prescription eyeglasses.

It is therefore another object of the present invention to secure a reinforced nose pad onto a pair of sunglasses or sunlenses and having an opening for receipt of a bridge portion of a pair of prescription eyeglasses.

It is yet another object of the present invention to secure a reinforced nose pad onto a pair of sunglasses or sunlenses and having an opening for receipt of a bridge portion of a pair of prescription eyeglasses with the nose pad having two openings or grooves, one for receipt of the bridge portion of the pair of sunglasses or sunlenses and one for receipt of the bridge portion of the pair of prescription eyeglasses.

It is still yet another object of the present invention to secure a reinforced nose pad onto a pair of sunglasses or sunlenses and having an opening for receipt of a bridge potion of a pair of prescription eyeglasses with the nose pad having two openings or grooves, one for receipt of the bridge portion of the pair of sunglasses or sunlenses and one for receipt of the bridge portion of the pair of prescription eyeglasses with the nose pad being held to the bridge portion of the pair of sunglasses or sunlenses by two horizontally extending screws passing through a front projection of the nose pad and engaging the bridge portion of the pair of sunglasses or sunlenses.

It is another object of the present invention to secure a reinforced nose pad onto a pair of sunglasses or sunlenses and having an opening for receipt of a bridge portion of a pair of prescription eyeglasses with the nose pad having two openings or grooves, one for receipt of the bridge portion of the pair of sunglasses or sunlenses and one for receipt of the bridge portion of the pair of prescription eyeglasses with the nose pad being held to the bridge portion of the pair of sunglasses or sunlenses by two horizontally extending screws passing through a front projection of the nose pad and engaging the bridge portion of the pair of sunglasses or sunlenses and with a rear projection of the nose pad aligning with the nose pads of the prescription eyeglasses.

These and other objects of the invention, as well as many of the intended advantages thereof, will become more readily apparent when reference is made to the following description taken in conjunction with the accompanying drawings.

### BRIEF DESCRIPTION OF THE DRAWINGS

FIG. 1A is a perspective view of a pair of prescription eyeglasses which will make use of the hook pad of the present invention for mounting a pair of sunglasses or sunlenses on the eyeglasses.

FIG. 1B is a perspective view of a pair of sunglasses having the hook pad of the present invention mounted thereon.

FIG. 2A is a bottom view of the hook pad of the present invention.

FIG. 2B is a rear view of the hook pad of the present invention.

FIG. 2C is a sectional view taken along line 2C-2C of FIG. 2B.

FIG. 2D is a right side view of the hook pad of the present invention.

FIG. 3A is a front view of an alternate pair of sunglasses including the hook pad of the present invention.

FIG. 3B is a detailed view of the hook pad mounted on the bridge portion of the sunglasses shown in FIG. 3A.

FIG. 3C is a front view of an alternate pair of sunglasses including the hook pad of the present invention.

FIG. 3D is a detailed view of the hook pad mounted on the bridge portion of the sunglasses shown in FIG. 3C.

FIG. 3E is a front view of an alternate pair of sunglasses including the hook pad of the present invention.

FIG. 3F is a detailed view of the hook pad mounted on the bridge portion of the sunglasses shown in FIG. 3E.

FIG. 3G is a front view of an alternate pair of sunlenses including the hook pad of the present invention.

FIG. 3H is a detailed view of the hook pad fitted on the sunlenses shown in FIG. 3G.

FIG. 3I is a front view of an alternate pair of sunlenses including the hook pad of the present invention.

FIG. 3J is a detailed view of the hook pad fitted on the sunlenses shown in FIG. 3I.

FIG. 4A is a plan view of a pair of sunglasses.

FIG. 4B is a front view of the sunglasses shown in FIG. 4A.

FIG. 4C is an exploded view of a hook pad to be mounted onto the sunglass frame.

FIG. 4D is a plan view of the sunglasses having a hook pad mounted thereon.

FIG. 4E is a front view of the hook pad mounted on the sunglasses.

FIG. 5A is a plan view of a pair of eyeglasses.

FIG. 5B is a plan view of a pair of sunglasses having a hook pad for mounting on the eyeglasses of FIG. 5A.

FIG. 6A is a front perspective view of a pair of eyeglasses.

FIG. 6B is a front perspective view of a pair of sunglasses having a hook pad to be mounted on the eyeglasses of FIG. 6A.

FIG. 6C is a front perspective view of a pair of eyeglasses.

FIG. 6D is a front perspective view of a pair of sunglasses having a hook pad to be mounted on the eyeglasses of FIG. 6C.

FIG. 6E is a front perspective view of a pair of eyeglasses.

FIG. 6F is a front perspective view of a pair of sunglasses having a hook pad to be mounted on the eyeglasses of FIG. 6E.

FIG. 6G is a front perspective view of a pair of eyeglasses.

FIG. 6H is a front perspective view of a pair of sunglasses having a hook pad to be mounted on the eyeglasses of FIG. 6G.

FIG. 7 is a plan view of a pair of eyeglasses having a pair of sunglasses mounted thereon and held in close contact to the eyeglasses by the nose pad of the present invention.

FIGS. 8A through 8E illustrate the mounting of alternative pairs of sunglasses or sunlenses on a pair of eyeglasses, by the use of the hook pad of the present invention.

FIG. 9A is a perspective view of a bridge portion of a pair of sunglasses having a pair of hook portions projecting therefrom for attachment of the sunglasses onto the bridge portion of a pair of prescription eyeglasses.

FIG. 9B is a side view of the hook projections of FIG. 9A.

FIG. 9C is a front view of one of the hook projections of FIG. 9A.

FIG. 9D is an exploded view illustrating the attachment of the pair of sunglasses, including the hook portions of the present invention, being positioned onto a pair of eyeglasses.

FIG. 9E illustrates the hook portions of the sunglasses latched behind the bridge portion of the eyeglasses.

FIG. 10A is an exploded view of a pair of sunglasses to be mounted onto a pair of eyeglasses with the hook portions of FIGS. 9A through 9E being used to also secure two temple portion extensions located on opposite sides of the bridge portion of the sunglasses.

FIG. 10B illustrates the interconnection of the hook portions of the bridge portion and the temple portion extensions onto a pair of eyeglasses.

FIG. 11A is a side view of a U-shaped connector to be used for securing a pair of sunglasses onto a pair of eyeglasses.

FIG. 11B is a front view of the U-shaped connector of FIG. 11A.

FIG. 11C is an exploded view illustrating the connection of two U-shaped connectors to a bridge portion of a pair of sunglasses so as to then secure the sunglasses to a pair of eyeglasses.

FIG. 11D illustrates the two U-shape connectors connected to a bridge portion of a pair of sunglasses and with the sunglasses then mounted onto a bridge portion of a pair of eyeglasses.

FIG. 12A is an exploded view using the U-shaped connectors of FIGS. 11A through 11D with additional U-shaped connectors located on temple portion extensions of the pair of sunglasses.

FIG. 12B illustrates the mounting of the pair of sunglasses onto a pair of eyeglasses with the U-shaped connector securing the respective bridge portions and temple portion extensions together.

FIG. 13A is a front view of a specialized bridge portion for connecting two sunlenses together.

FIG. 13B is a side view of the bridge connector portion.

FIG. 13C is an exploded view illustrating how a pair of sunlenses fit with and are connected to the bridge connector portion.

FIG. 13D illustrates the two sunlenses interconnected by the bridge connector portion and the mounting of the two sunlenses onto a pair of eyeglasses by the use of a bridge connector portion.

FIG. 14A is a front view of an alternative connector to be used with a specialized pair of sunglasses.

FIG. 14B is an enlarged side view of the connector shown in FIG. 14A.

FIG. 14C is an exploded view illustrating an opening in a bridge portion of a pair of sunglasses of a size to accommodate a projection of the connector so as to mount the connector onto the pair of sunglasses.

FIG. 14D illustrates the mounting of the connector onto the bridge portion of the sunglasses and the connector engaging the bridge portion of a pair of eyeglasses to mount the sunglasses on the eyeglasses.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

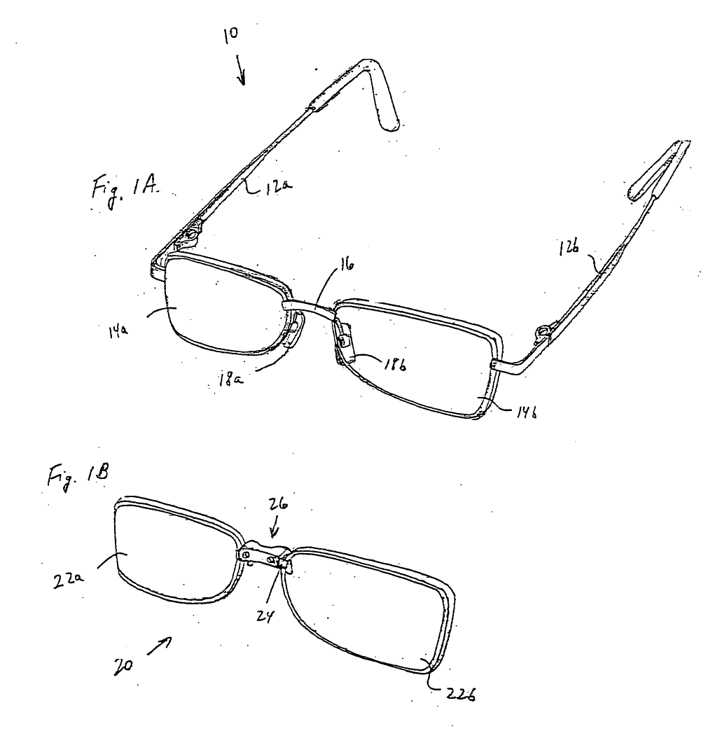

In FIG. 1, a pair of eyeglasses 10 includes temples 12a, 12b and lenses 14a, 14b interconnected by a bridge portion 16. Extending from the bridge portion 16 are nose pads 18a, 18b.

A pair of sunglasses 20 are to be mounted on the pair of eyeglasses 10. The pair of sunglasses 20 includes lenses 22a, 22b interconnected by a bridge portion 24. Secured to the bridge portion 24 is a nose pad 26.

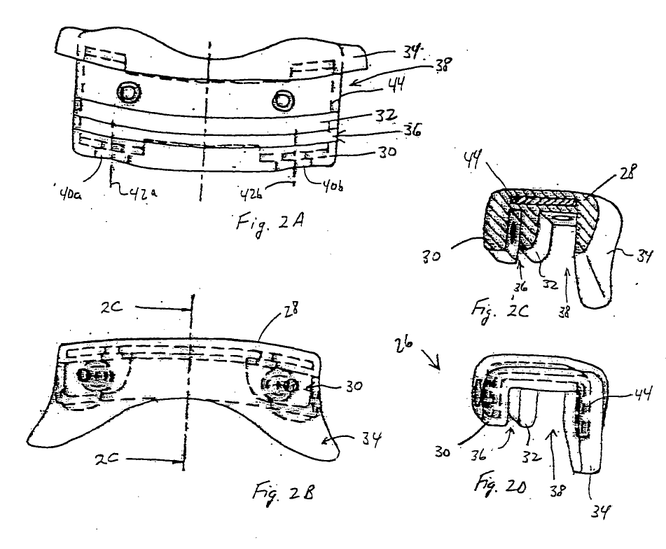

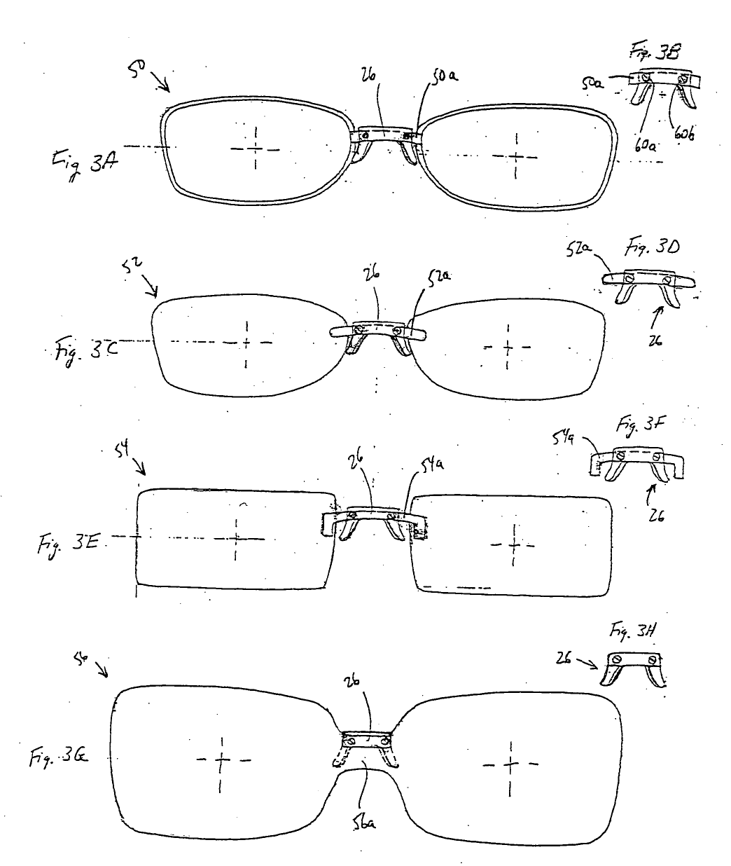

As shown in greater detail in FIGS. 2A through 2D, the nose pad includes three rows of projections. All three projections are interconnected by a cross piece 28, with all of the projections extending in the same direction from the cross piece 28. More specifically, with reference to FIGS. 2A through 2D, nose pad 26 includes front projection 30, central projection 32 and rear projection 34.

Defined between the front projection 30 and central projection 32 is a groove or opening 36 for receipt of the bridge portion of a pair of sunglasses or sunlenses. A second groove or opening 38 is defined between the central projection 32 and rear projection 34 for receipt of the bridge portion of a pair of eyeglasses 10 onto which the sunglasses or sunlenses are to be mounted.

Spaced across a front surface of front projection 30 are two screw holes 40a, 40b for receipt of screws having center lines 42a, 42b, respectively. When inserted, the screws engage the bridge portion 24 of a pair of sunglasses or sunlenses and press the bridge portion against the central projection 32 so as to hold the bridge portion 24 in place. Alternatively, the screws engage a screw hole in the bridge portion of the sunglasses for engagement therein.

The nose pad 26 is reinforced by a U-shaped metal plate 44 schematically illustrated in dotted lines in FIG. 2A, 2B and 2D. The metal plate extends centrally in front projection 30 at the approximate locations of the screws entering the screw holes 40a, 40b of the front projection. The metal plate 44 then travels across the cross piece 28 and turns 90 degrees into the rear projection 34 as best shown in FIG. 2D. As shown in FIG. 2C, the metal plate 44 at the center of nose pad 26 is only present in cross piece 28.

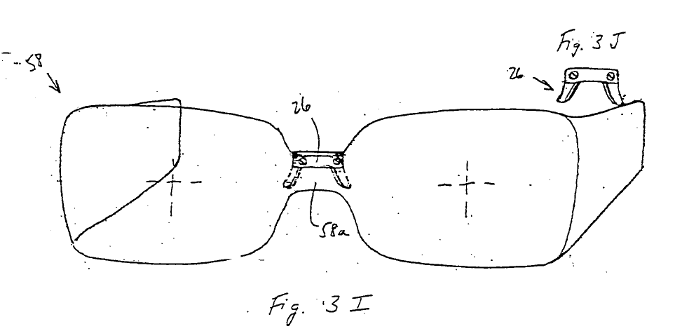

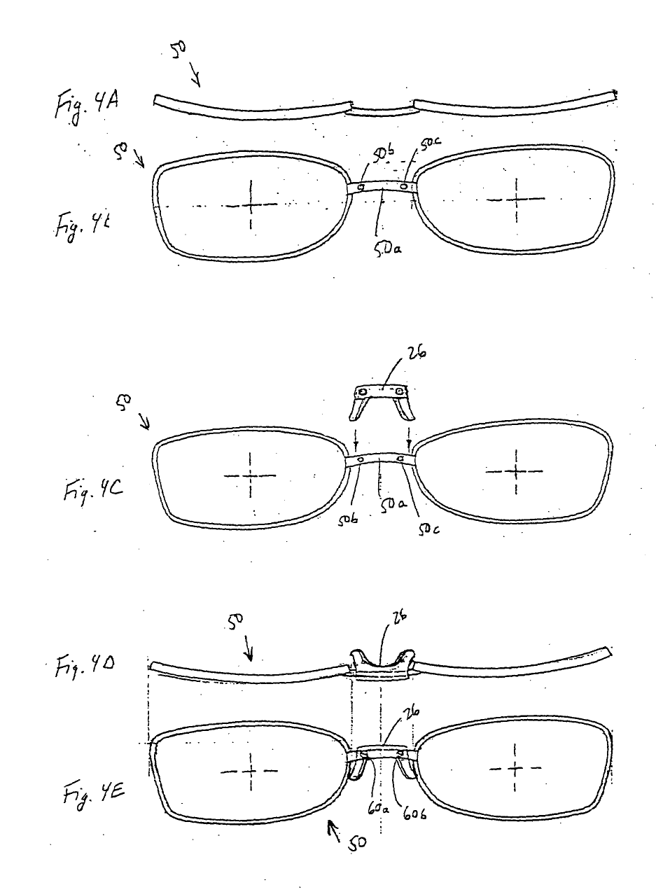

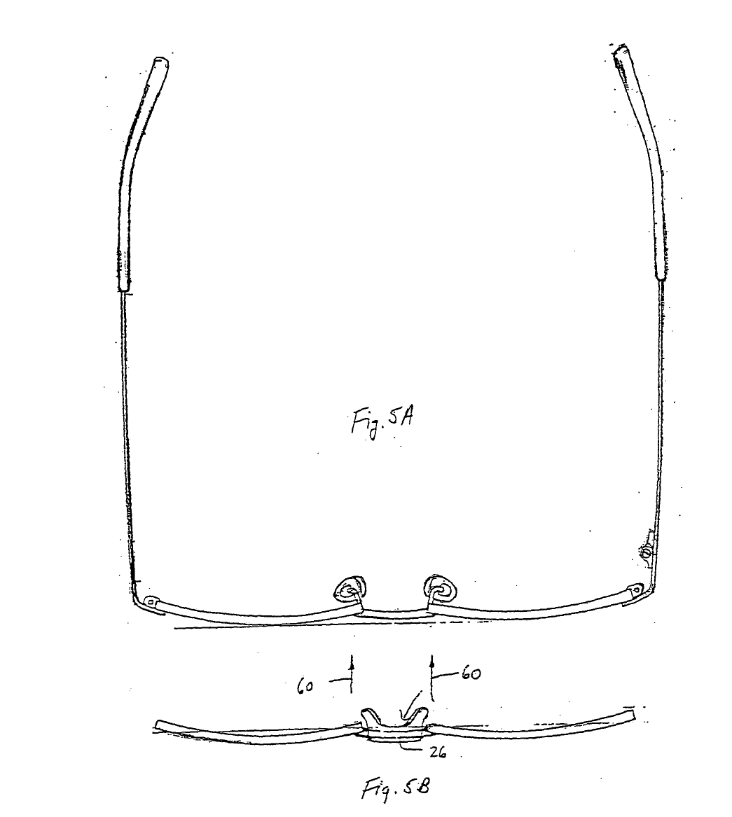

As shown in FIGS. 3A through 3J, a plurality of sunglasses 50, 52, 54 and sunlenses 56, 58 each include a respective bridge portion 50a, 52a, 54a, 56a, 58a onto which a nose pad 26 has been mounted by two screws 60a, 60b as shown by example with reference to FIG. 3B. The same screws are used in all of the embodiments shown in FIGS. 3A through 3J.

In FIGS. 4A through 4E, additional details of the mounting of the sunglasses 50 onto a pair of eyeglasses are shown. In this embodiment as shown in FIG. 4B, the bridge portion 50a of the sunglasses 50 may already include screw holes 50b, 50c. When the nose pad 26 is mounted onto the bridge portion 50a as shown in exploded view FIG. 4C and as shown connected in FIGS. 4D and 4E on the sunglasses 50, the screws 60a, 60b pass through the nose pad 26 and engage in the screw holes 50b, 50c in the bridge portion 50a.

FIGS. 5A and 5B show the movement of sunglasses having the nose pad 26 in the direction of arrow 60 to engage a pair of eyeglasses.

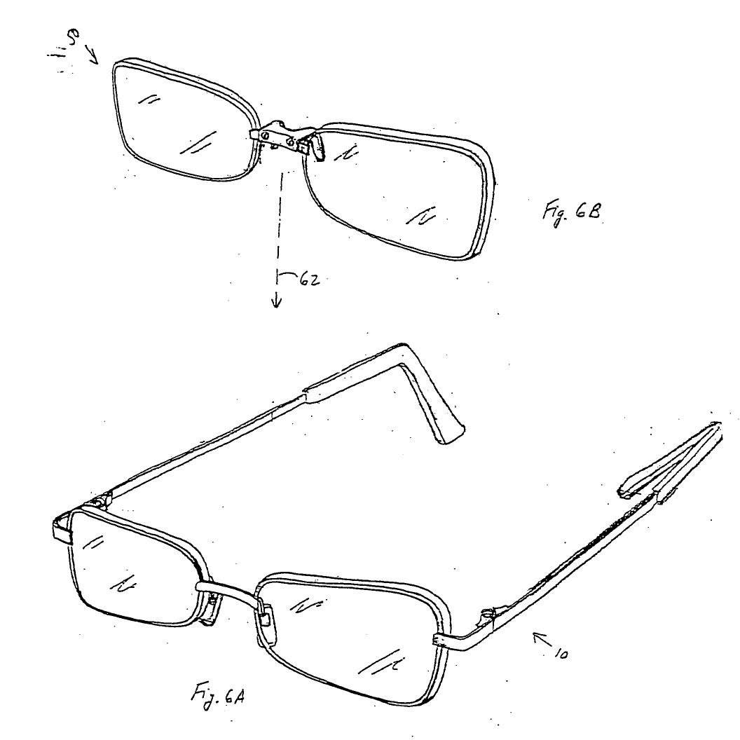

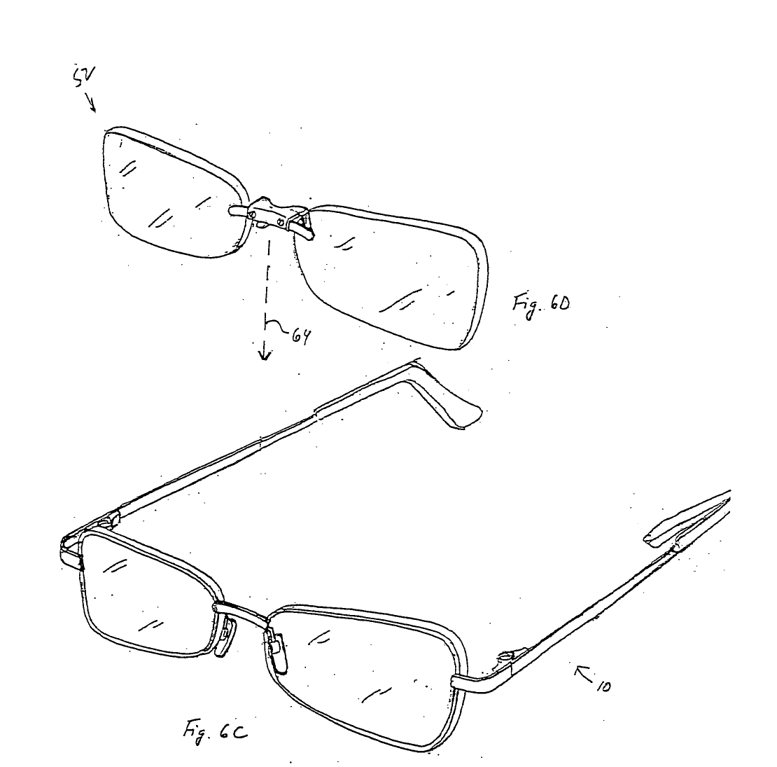

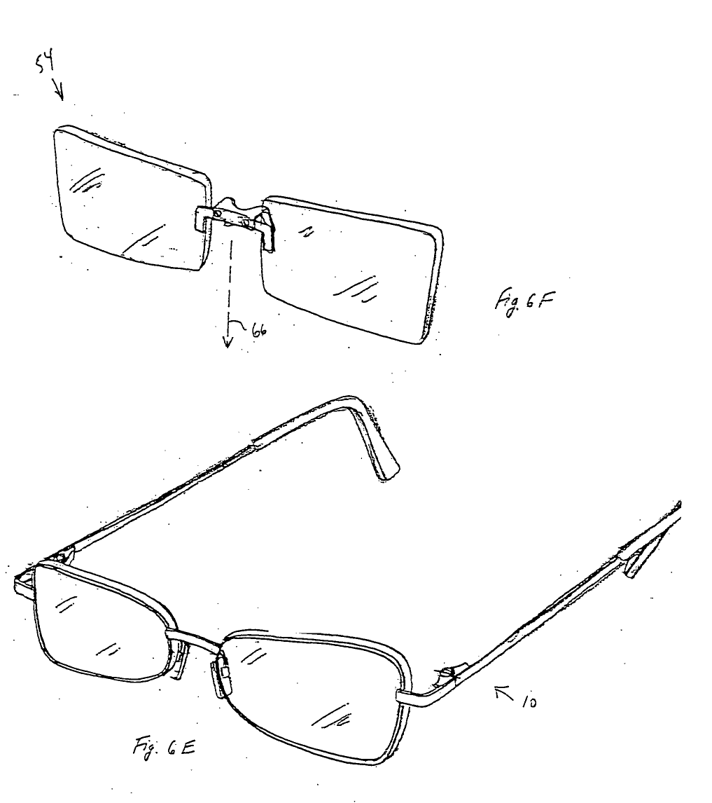

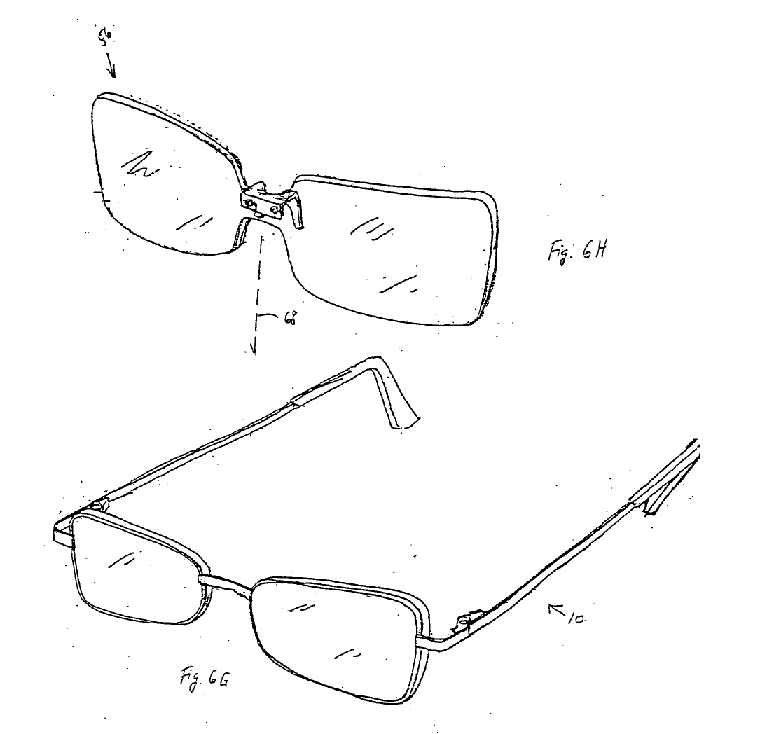

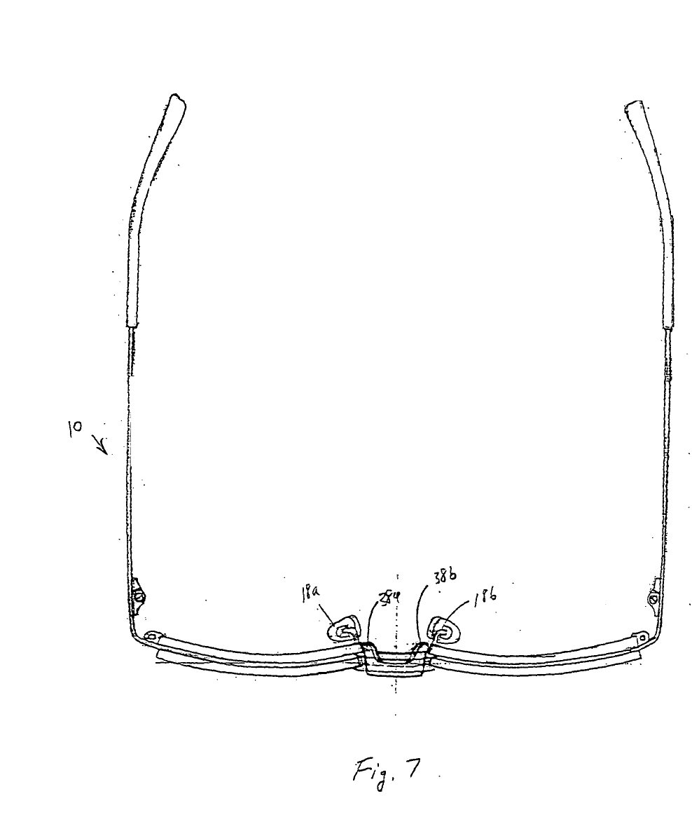

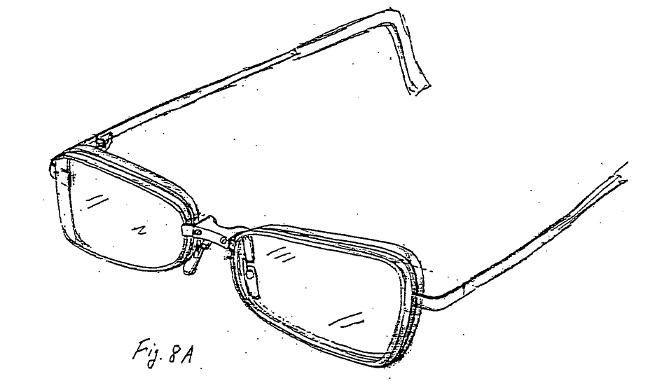

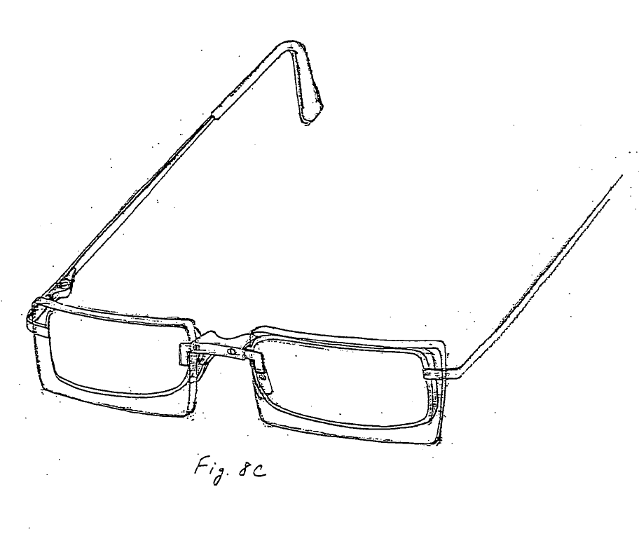

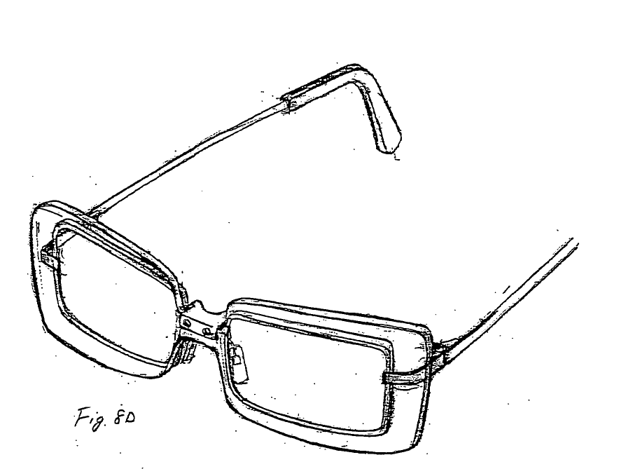

FIGS. 6A and 6B show the mounting of the sunglasses 50 onto a pair of eyeglasses in the direction of arrow 62 with the end result shown in FIG. 8A. Similarly FIGS. 6C and 6D show the mounting of sunglasses 52 onto a pair of eyeglasses 10 by movement in a direction of arrow 64 with the end result shown in FIG. 8B. Similarly, FIG. 6E and 6F show the mounting of sunglasses 54 onto a pair of eyeglasses 10 by movement in the direction of arrow 66 with the end result shown in FIG. 8C.

FIGS. 6G and 6H show the mounting of a pair of sunlenses 56 onto a pair of eyeglasses 10 by movement in the direction of arrow 68 with the end result shown in FIG. 8D. Finally, FIG. 8E shows the mounting of the sunlenses 58 (as shown in FIGS. 3I) mounted onto a pair of eyeglasses 10.

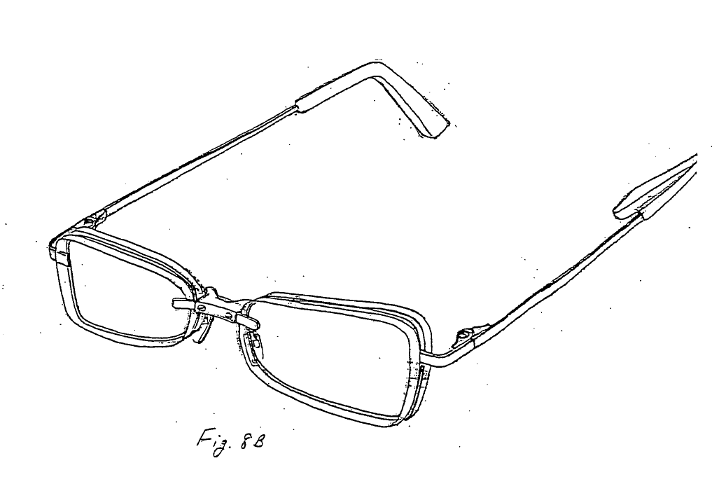

FIG. 7 illustrates the mounting of the sunglasses shown in FIG. 5B onto a pair of eyeglasses 10 as shown in FIG. 5A. After the mounting of the sunglasses onto the eyeglasses, it is noted that the divergent portions 38a, 38b of the rear projection 38 define an opening for the nose and assist in the positioning of the eyeglasses with the nose pads 18a, 18b.

Accordingly, by the present invention, a relatively simply formed nose pad is manufactured to position many varied types of sunglasses or sunlenses onto a pair of eyeglasses. As long as a bridge or nose portion is present in the sunglasses or sunlenses, the sunglasses or sunlenses may be mounted onto a pair of eyeglasses by the use of a nose pad of the present invention.

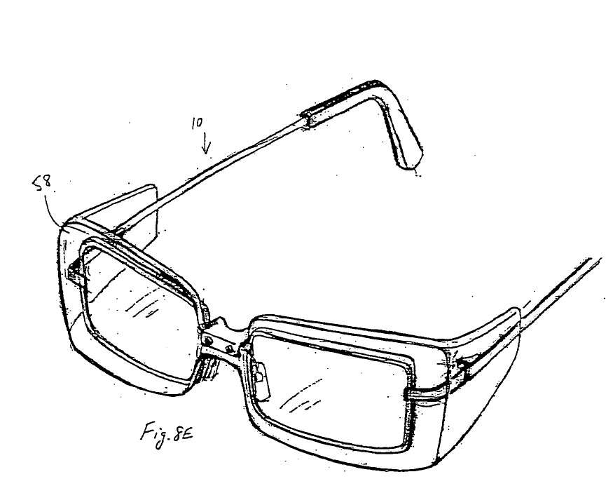

In alternative versions of the present invention, such as in FIGS. 9A through 9E, two hook portions 100 are secured to a bridge portion 102 of a pair of sunglasses 104. The hook portions are secured at one end 106 and are bent through an angle of approximately 90 degrees to terminate in end 108 having cushion cover 110 secured thereon.

To assemble the sunglasses 104 onto a pair of eyeglasses 112, having bridge portion 114, the end 108 of the projections 100 is forced behind the bridge portion 114 of the pair of eyeglasses so that the cushion members 110 engage a rear surface of the bridge portion 114 to hold the sunglasses in front of the eyeglasses as shown in FIG. 9E. The horizontal width extension between ends 106 and 108 of the projection 100 may be dimensioned such that the bridge portion 102 requires a force to pass the end 108 of the projection beyond the bridge portion 114. This in effect will create a bias or springy force holding the sunglasses onto the eyeglasses 112. To remove the sunglasses 104, force may be exerted onto bridge portion 102 to move the bridge portion 102 in the direction of bridge portion 114 so as to release the end 108 from behind the bridge portion 114. The sunglasses 104 may thereby be removed from the eyeglasses 112.

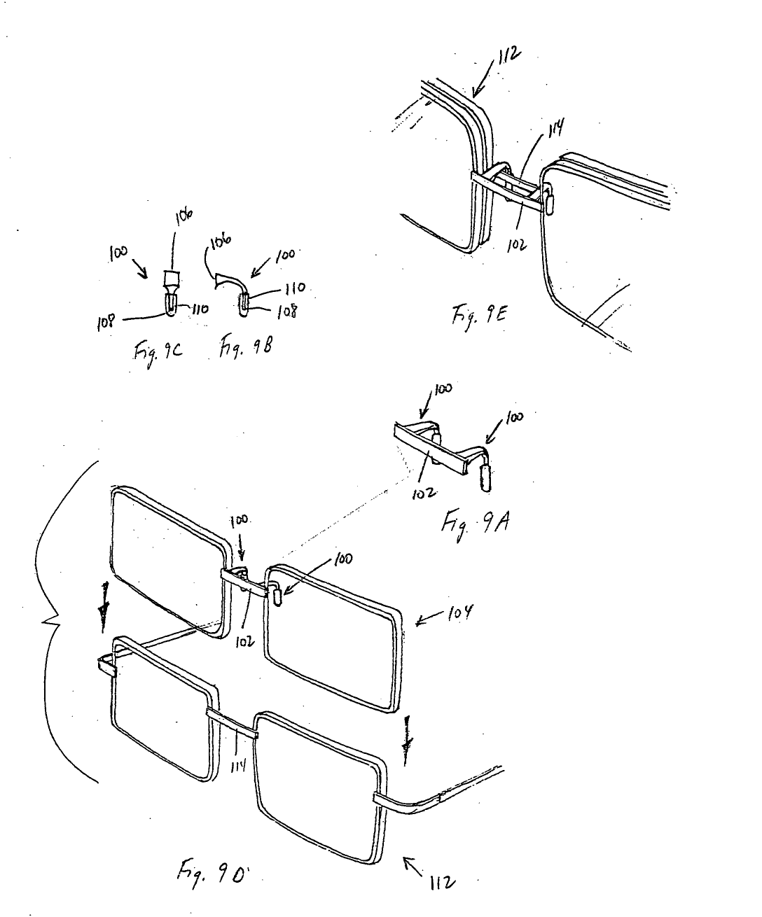

In FIGS. 10A and 10B, a similar arrangement as shown in FIGS. 9A through 9E is used. However, sunglasses 116 include temple portion extensions 118 on an outer side of each of the sunglass lenses. Projecting rearwardly from the extensions 118 are projections 100 as are also present on the bridge portion 102.

As shown in FIG. 10B, the sunglasses 116 are secured to the eyeglasses 112 by not only the interconnection of the bridge portions 102, 114 by projections 100 but also at the temple portions 120 of the eyeglasses where the projection 100 from the temple portion extension 118 is moved to position the end 108 of the projections 100 behind the temple portion 120 of the eyeglasses 112.

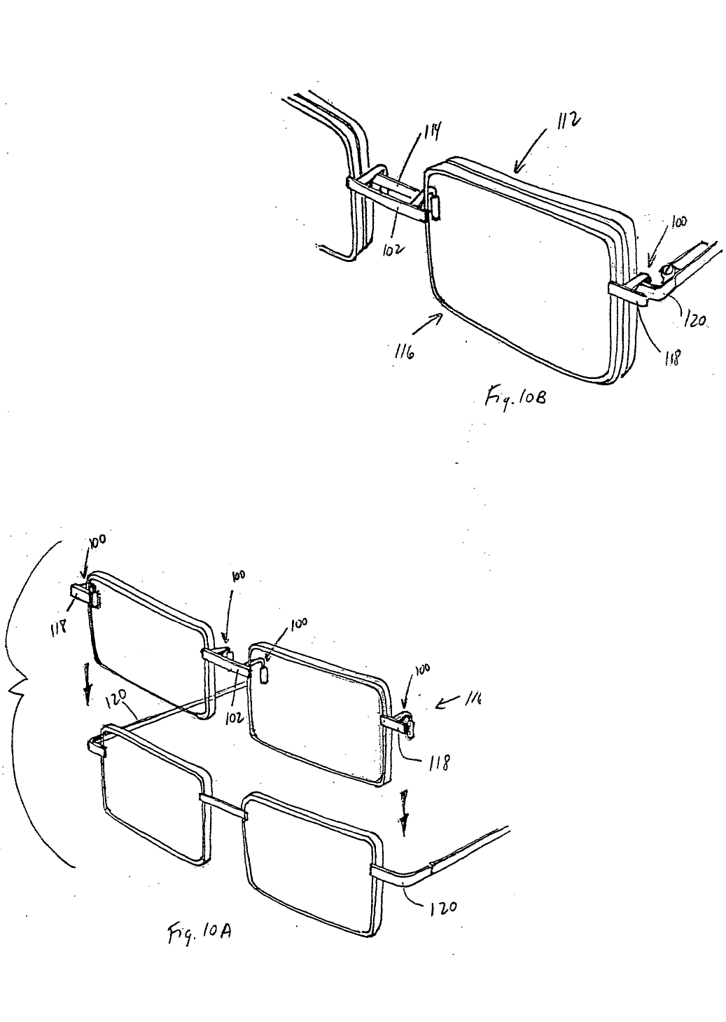

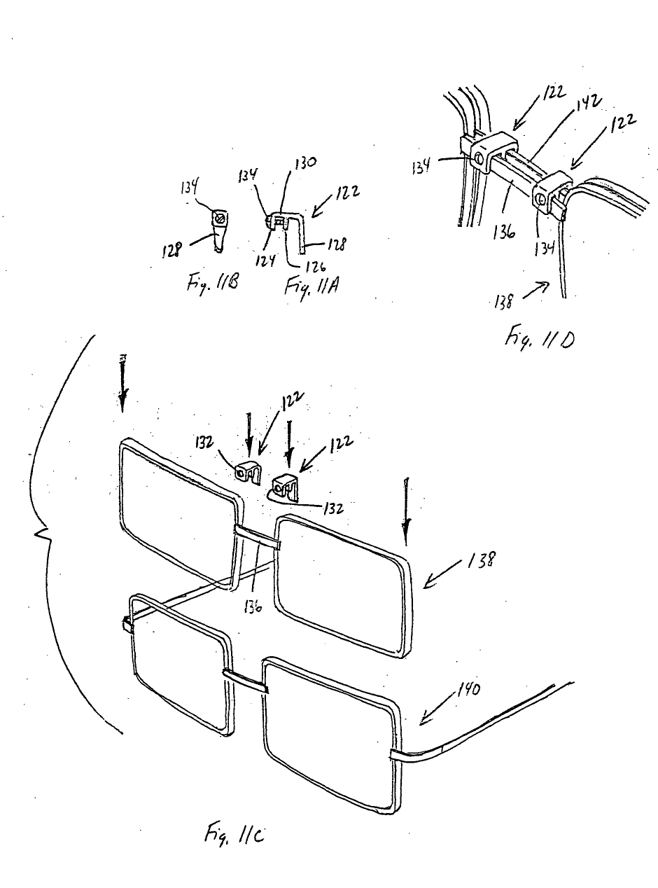

In an alternate arrangement as shown in FIG. 11A, a U-shaped connector 122 includes a front projection 124, a central projection 126 and rear projection 128 interconnected by cross piece 130. Extending through an opening 132 in front projection 124 is a screw 134 which is threadably mounted in opening 132 and extends to central projection 126. Two U-shaped connectors 122 are mounted onto a bridge portion 136 of a pair of sunglasses 138 so as to mount the sunglasses 138 on a pair of eyeglasses 140.

As shown in FIG. 11D, the U-shaped connectors 122 are secured to bridge portion 136 of the sunglasses 138 by screws 134 extending through the front projection 124 and engaging the bridge portion 136. The bridge portion 136 is forced against the central projection 126 by continued rotation of the screws 134.

With the U-shaped connectors 122 connected to the bridge portion 136, the sunglasses 138 are mounted onto the bridge portion 142 of the eyeglasses 140. The bridge portion 142 is received in the gap between the central projection 126 and rear projection 128 of the U-shaped connectors 122.

In FIGS. 12A and 12B, the same U-shaped connectors 122 as described with reference to FIGS. 11A through 11D are used. However, in this embodiment, the sunglasses 144 include temple portion extensions 146 located on outer sides of the lenses of the sunglasses 144. U-shaped connectors 122 are secured to the temple portion extensions 146 for securing the sunglasses 144 to the eyeglasses 140 at the bridge portion 136 of the pair of sunglasses 144 as well as to the temple portions 148 of the eyeglasses 140.

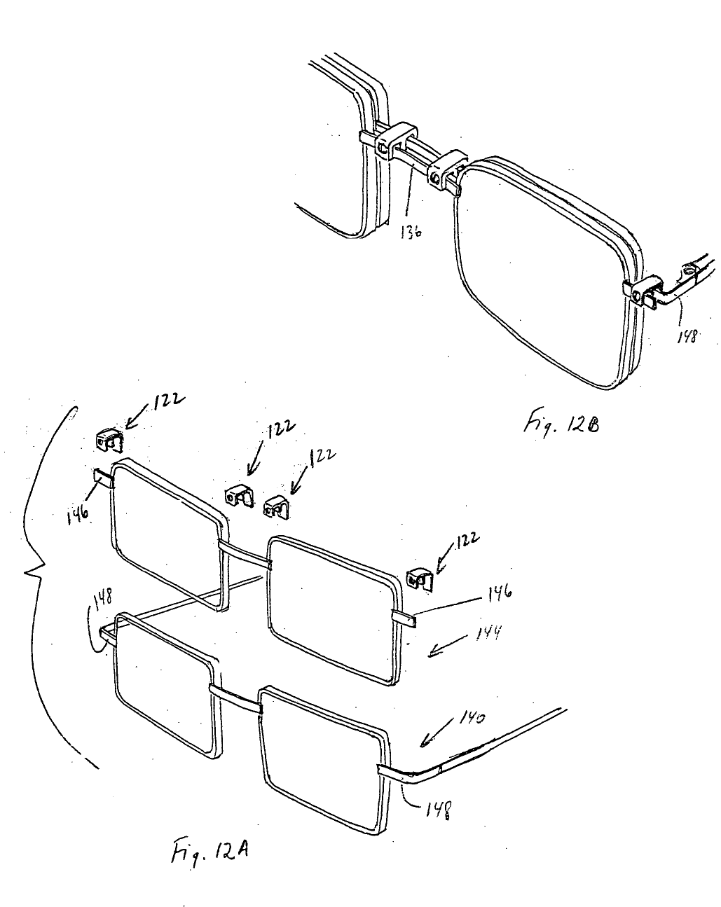

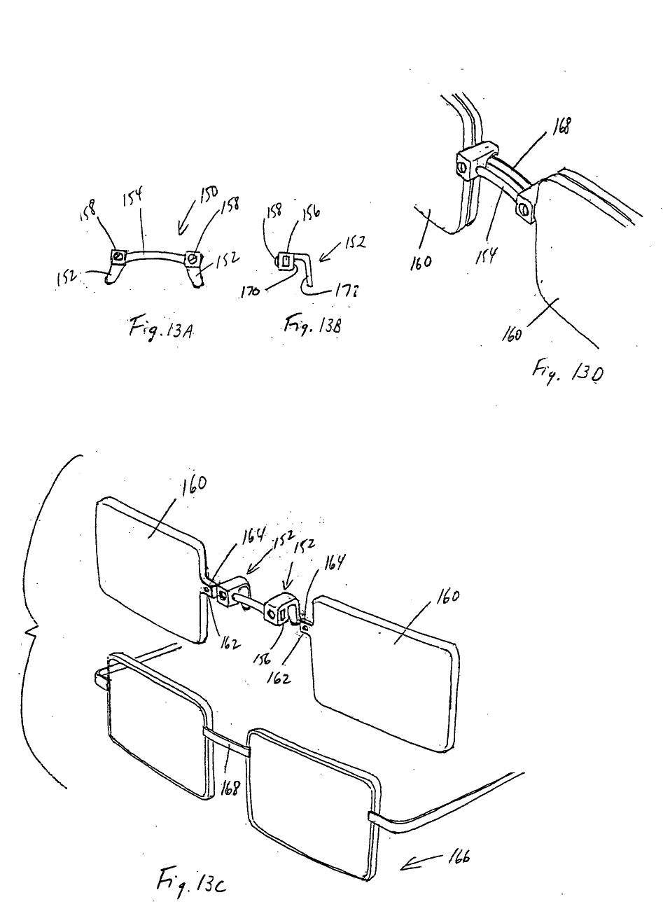

In an another arrangement as shown in FIGS. 13A through 13D, a bridge connector portion 150 includes two end portions 152 and a central interconnecting bar 154. The end portions 152 include an opening 156 which opens to a side of the end portion 152. A screw 158 extends through a front surface of the bridge connector portion 150 and into the opening 156.

As shown in FIG. 13C, two sunlenses 160 include an inwardly projecting tab 162 having a hole 164 therein. The tab 162 is dimensioned to fit into the opening 156 of the end pieces 152. Once the tabs 162 are positioned inside the openings 156, screws 158 are tightened through the opening in the front of the bridge connector so as to secure the sunlenses 160 to the bridge connector portion 150.

This assembly is then mounted onto a pair of eyeglasses 166 and specifically the bridge portion 168 of the eyeglasses 166 by engagement of the bridge portion 168 between a rear wall 170 of the end portions 152 and a downwardly extending projection 172. The gap formed between wall 170 and projection 172 fits over the bridge portion 168 to maintain the bridge connector portion 150 and its secured sunlenses 160 in place in front of the eyeglasses 166.

In still yet another alternate embodiment, a connector 171 includes a specialized configuration having a front projection 173 and a rear projection 174. A cross piece 176 interconnects the projections 173, 174.

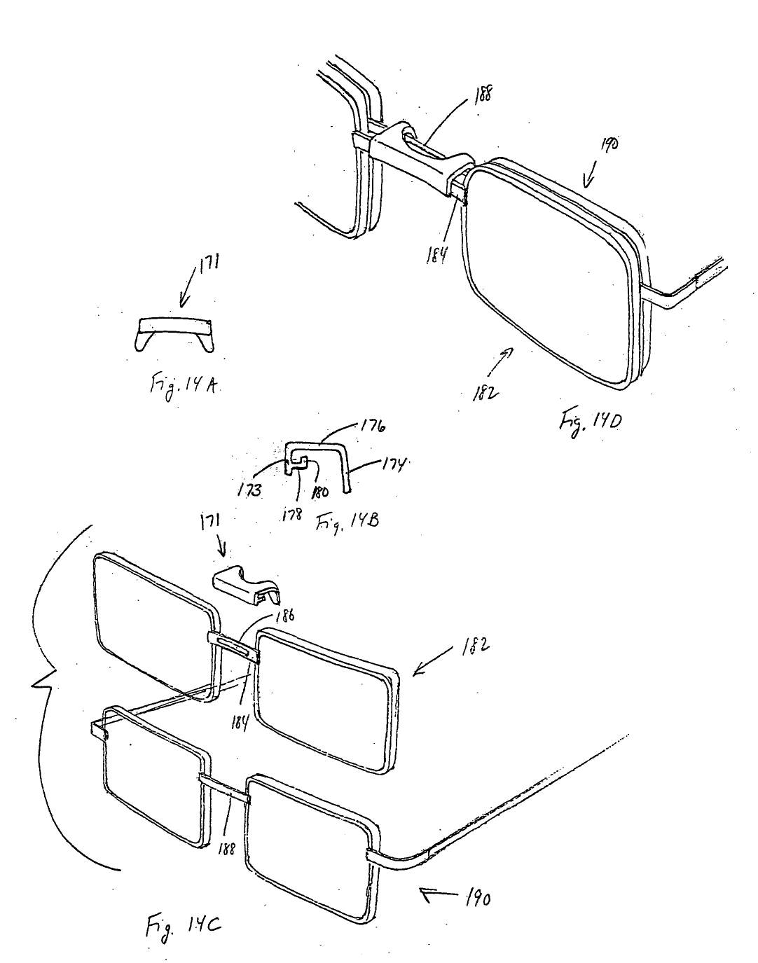

Projecting rearwardly from projection 173 is an extension 178 terminating in an upwardly extending projection 180. A specialized pair of sunglasses 182 include a bridge portion 184 having a central elongated slot 186. The upstanding projection 180 is configured to fit through the slot 186 and by rotation of the connector 171 the upper surfaces and lower surfaces of the slot 186 are engaged by the upper and lower surfaces of the extension 178. The connector 171 is thereby mounted onto the sunglasses 182. A gap between a rear surface of the projection 180 and rear projection 174, shown on an enlarged skill in FIG. 14B, is sufficient to surround and engage a bridge portion 188 of a pair of eyeglasses 190 as shown in FIG. 14D.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

I claim:

1. A connector for attaching to a pair of sunglasses and for positioning the pair of sunglasses onto a pair of eyeglasses, said connector comprising:
a body including a front projection, a central projection and a rear projection,
a first opening defined between said front projection and said central projection for receipt of a bridge portion of the sunglasses, and
a second opening defined between said central projection and said rear projection for receipt of a bridge portion of the pair of eyeglasses to mount said sunglasses or sunlenses onto said eyeglasses.

2. The connector as claimed in claim 1, wherein said front projection, said central projection and said rear projection extend in a same direction from a cross piece of the body.

3. The connector as claimed in claim 1, wherein at least one screw extends through said front projection for engaging the bridge portion of the sunglasses located in said first opening.

4. The connector as claimed in claim 1, wherein said front projection includes a screw hole for receipt of a screw passing through said front projection for engaging the bridge portion of the sunglasses located in said first opening.

5. The connector as claimed in claim 1, wherein said rear projection is longer than said front projection.

6. A sun screening assembly for positioning on a pair of eyeglasses, said sun screening assembly comprising:
a pair of sunglasses, and
a connector having a body including a front projection, a central projection and a rear projection,
a first opening defined between said front projection and said central projection for receipt of a bridge portion of the sunglasses, and
a second opening defined between said central projection and said rear projection for receipt of a bridge portion of the pair of eyeglasses to mount said sunglasses onto said eyeglasses.

7. The sun screening assembly as claimed in claim 6, wherein said front projection, said central projection and said rear projection extend in a same direction from a cross piece of the body.

8. The sun screening assembly as claimed in claim 6, wherein a screw extends through a screw hole of said front projection for engaging the bridge portion of the sunglasses located in said first opening.

9. The sun screening assembly as claimed in claim 8, wherein said bridge portion of said sunglasses includes two connectors each having said screw hole for receipt of screws passing through said front projection for engaging the bridge portion of the sunglasses located in said first opening.

10. The sun screening assembly as claimed in claim 9, wherein said pair of sunglasses includes two temple portion extensions each having a connector for maintaining said temple portion extensions on the pair of eyeglasses.

11. A sun screening assembly for positioning on a pair of eyeglasses, said sun screening assembly comprising:
a bridge connector portion having two ends,
a connector secured on each of said two ends of said bridge connector portion,
two sunlenses, each sunlenses including a tab secured to the connector on each end of the bridge connector portion,
a gap in each of said connectors for receiving a bridge portion of the pair of eyeglasses.

12. A sun screening assembly as claimed in claim 11, wherein each connector includes a side opening for a receipt of the tab of one of the two sunlenses.

13. A sun screening assembly as claimed in claim 12, wherein each connector includes a screw opening with a screw therein for holding the tab of the sunlens in said connector.

14. A sun screening assembly as claimed in claim 13, wherein each connector includes a rear projection, the gap of each connector is between said rear projection and a rear wall of a portion of the connector which includes the side opening defining a space for receipt of the bridge portion of the pair of eyeglasses.

15. A sun screening assembly for positioning on a pair of eyeglasses, said sun screening assembly comprising:
a pair of sunglasses including two sunlenses interconnected by a bridge portion, said bridge portion including an elongated slot,
a connector for maintaining the sunglasses on the pair of eyeglasses, the connector including a front projection and a rear projection interconnected by a crosspiece, and
a portion of the front projection of the connector fitting in the elongated slot of the bridge portion for connecting the connector to the pair of sunglasses and for mounting the sunglasses on the pair of eyeglasses.

16. A sun screening assembly as claimed in claim 15, wherein the front projection includes an extension extending towards the rear projection and terminating in an upstanding projection, the extension is located in the elongated slot when the connector is mounted on the bridge portion of the sunglasses.

17. A sun screening assembly for positioning on a pair of eyeglasses, said sun screening assembly comprising:
a pair of sunglasses including two sunlenses interconnected by a bridge portion,
two connectors projecting from the bridge portion for mounting the sunglasses on the pair of eyeglasses.

18. A sun screening assembly as claimed in claim 17, wherein the connectors are L-shaped.

19. A sun screening assembly as claimed in claim 18, wherein the pair of sunglasses includes two temple portion extensions, each temple portion extension including a connector for engaging with a respective temple portion of the pair of eyeglasses.

20. A sun screening assembly as claimed in claim 19, wherein each of the connectors include a cushion at a terminal end.
